(19) United States
(12) Patent Application Publication
(10) Pub. No.: US 2002/0157270 A1
(43) Pub. Date: Oct. 31, 2002

(54) Golf club shaft measuring apparatus

(76) Inventor: Victor Maraschiello, Flat Rock, NC (US)

Correspondence Address: John B. Hardaway, III, Nexsen Prute Jacobs & Pollard LLC, PO Box 10107, Greenville, SC, 29603, US

(21) Appl. No.: 09/796,044

(22) Filed: Feb. 28, 2001

Related U.S. Application Data
(60) Provisional application No. 60/187,432, filed on Mar. 7, 2000.

(51) Int. Cl. G01B 3/04

(52) U.S. Cl. 33/508; 33/484

(57) ABSTRACT

The present invention describes a golf shaft measuring device comprising a base, a shaft alignment device attached to the base, an alignment plate also attached to the base and perpendicular to the shaft alignment device, a slide attached to the alignment plate and an indexing guide slidably attached to said base.

### RELATED APPLICATIONS

The application is related to, and claims priority to, U.S. Provisional Patent Application 60/187,432 filed Mar. 7, 2000.

### BACKGROUND

The present invention is related to an apparatus for accurately measuring a golf club shaft prior to cutting. More specifically, the present invention is related to an apparatus for accurately measuring a golf club shaft with or without a golf club head mounted.

The accurate measurement of a golf shaft is a critical parameter in the art of custom golf club assembly. To ensure consistency in performance the difference in length of the shaft between each club in a matched set must be precise. For example, in a standard set each iron has a shaft length which is ½ inch longer than the previous club with more loft. A 4 iron, for example, has a shaft which is ½ inch longer than the shaft of a 5 iron. If the length of a shaft is incorrect then the relative performance of one club versus a matched club of the same set will be inconsistent leading to errant shots and frustration.

Presently, shaft measurement among club builders is done with a standard ruler or with a plate device as shown in FIGS. 1 and 2. FIG. 1 illustrates a side view as utilized with a shaft, 8, comprising a golf head, 7. FIG. 2 illustrates a top view as utilized with a shaft, 8, that does not have a golf head mounted thereon. The device in FIGS. 1 and 2 is the same. The plate device comprises a two part base plate, 1, which has a hinge in the center, 2. A guide plate, 3, is rotatably attached to the base plate. The club is placed against the guide plate and the length of the shaft is determined by the ruler, 4, the shaft is marked and taken to another station for cutting. The deficiencies of this apparatus are numerous. One of the most critical deficiencies is in the guide plate. The sole of the club is usually rounded to some extent and may include rails, depressions, dimples, or various other shapes and contours designed to assist with improved accuracy or improved marketing as is common in golf club head design. If the guide plate is at an improper angle the measurement will be incorrect. The instructions for the prior art device suggest that the edge, 5, of the guide plate, 3, be visually aligned with the grooves, 6, of the golf club head, 7. Even if the grooves are aligned with the edge the face of the club may be rotated relative to the axis of the shaft which would lead to an incorrect measurement. This leads to inaccuracy and waste. Yet another disadvantage is the human error involved in making a set of clubs wherein each measurement is different. In a working shop it is not uncommon for the club professional to be distracted during the course of manufacturing a set of clubs. Since each set has a different base length the club professional must return to the set, remember which club is being prepared (i.e. the 5 iron or 6 iron), account for the offset from standard length, align the shaft or club head properly, mark and cut. It is not uncommon for the club professional to incorrectly measure and cut the shaft which leads to waste in time and materials. Yet another deficiency is the fact that the shaft may not be perfectly parallel to the ruler, 4. This leads to inaccuracies.

There has been a long felt desire in the art for a club shaft measuring device which is convenient, accurate and which contains a template which can be used to prepare a matched set of clubs.

### SUMMARY

It is an object of the present invention to provide a golf shaft measuring device which is accurate and easy to use.

It is another object of the present invention to provide a golf shaft measuring device which eliminates the errors associated with differences in the sole shape of different golf club heads.

It is another object of the present invention to provide a golf shaft measuring device which has an index method such that each shaft of a set is a predetermined offset from the previous shaft.

These and other advantages, as will be apparent from the description, are provided in a golf shaft measuring device comprising a base, a shaft alignment device attached to the base, an alignment plate also attached to the base and perpendicular to the shaft alignment device, a slide attached to the alignment plate and an indexing guide slidably attached to the base.

Another embodiment is provided in a device for measuring a golf shaft wherein then golf shaft comprises a golf head and the device comprises a base. A shaft alignment device is attached to the base. An alignment plate is pivotally attached to the base and is capable of contacting the golf head. A slide comprising a groove aligner is attached to the alignment plate and is parallel to the alignment plate. The alignment plate can be rotated such that the groove aligner is parallel to a groove on the golf head when the golf head is in contact with the alignment plate. An indexing guide is slidably attached to the base.

A particularly preferred embodiment is provided in a method for determining a golf club lie angle of a golf club. The method comprises the steps of:

a) placing the golf club in a golf club alignment device comprising a shaft alignment device;

an alignment plate attached perpendicular to the shaft alignment device and in contact with a golf head of the golf club; and

a slide attached to the alignment plate wherein the slide is parallel to a groove of said golf head;

b) placing a protractor on the golf club alignment device wherein the protractor comprises an indexing section and an angle section and said protractor is oriented such that the alignment section is parallel to the shaft and the angle section is parallel to the slide;

c) reading an angle on the protractor corresponding to the lie angle.

A method for determining a loft angle of a golf club wherein the golf club comprises a shaft and a golf head and the golf head comprises a sole, a face and a groove, the method comprising the steps of:

a) placing the golf club in a golf club alignment device comprising a shaft alignment device for orienting the shaft;

an alignment plate in contact with the sole; and

a slide parallel to the alignment plate and parallel to the groove;

b) placing a protractor on the golf club alignment device wherein the protractor comprises an indexing section and an angle section and the protractor is oriented such that the alignment section is parallel to the alignment plate and the angle section is parallel to the face;

c) reading an angle on said protractor corresponding to said loft angle.

Yet another embodiment is provided in a method for forming a golf club from a golf shaft and a golf head. The method comprises the steps of:

a) placing the golf shaft in a shaft alignment device wherein the shaft alignment device comprises a alignment plate rotatable to a position perpendicular to the golf shaft;

b) measuring the golf shaft with an tip indexing guide wherein said tip indexing guide comprises a peak indicating the length of the golf shaft to remove;

c) removing a portion of the golf shaft corresponding to the peak;

d) attaching the golf head to the shaft;

e) placing the shaft in the shaft alignment device and contacting the golf head with the alignment plate wherein the alignment plate comprises a slide parallel to the alignment plate and the alignment plate is rotated such that the slide is parallel to a groove of the golf head;

f) measuring the golf shaft with an indexing guide wherein the indexing guide comprises a length peak indicating the length of the club;

g) removing a portion of the shaft corresponding to the length peak.

### BRIEF DESCRIPTION OF DRAWINGS

FIG. 1 is a side view of a prior art golf club shaft measuring apparatus as used with a shaft having a golf head attached thereto.

FIG. 2 is a top view of the prior art golf club shaft measuring apparatus as used with a shaft not having a golf head attached thereto.

FIG. 3 is a partial side view of an embodiment of the present invention.

FIG. 4 is a partial side view of the alignment plate of a preferred embodiment.

FIGS. 5 and 6 are a top view and side view, respectively of a preferred slide.

FIG. 7 is an end view of a preferred embodiment.

FIG. 8 is a perspective view of the golf club shaft measuring device with a club inserted as it would be in actual use.

FIG. 9 is a perspective view of the golf club shaft measuring device without a club.

FIG. 10 is a perspective view of the inventive device as it would be employed to measure the lie of a golf club.

FIG. 11 is a top view of the inventive device as it would be used to measure the loft of a golf club.

FIG. 12 is a side view illustrating preferred indexing guides of the present invention.

FIG. 13 is a perspective partial view of an embodiment of the present invention.

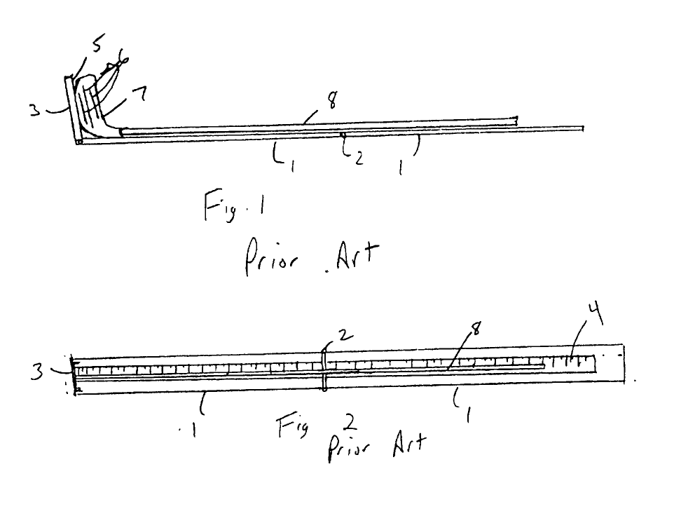

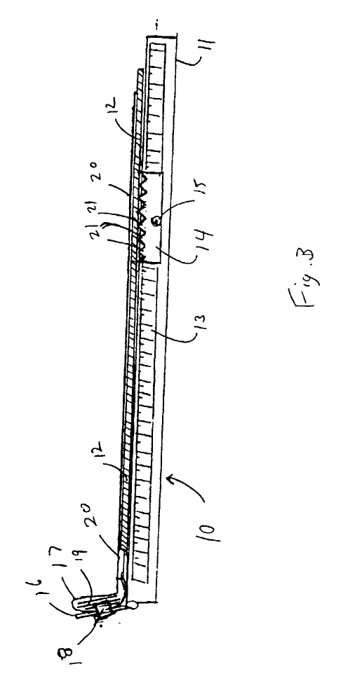

### DETAILED DESCRIPTION

The golf club measuring apparatus of the present invention will be described in reference to the drawings wherein similar elements are numbered accordingly.

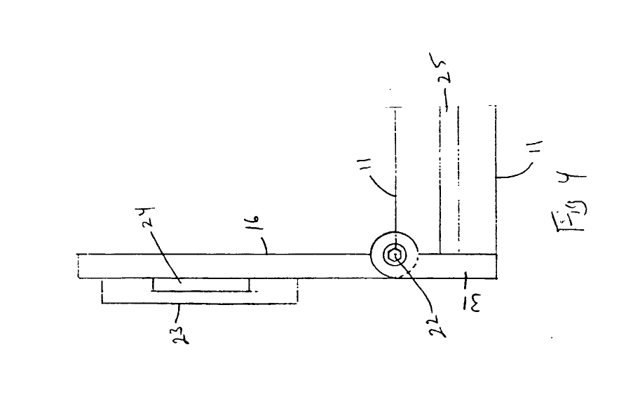

FIG. 3 is a side view of the golf shaft measuring apparatus generally illustrated at 10. The golf shaft measuring apparatus comprises a base, 11. Attached to the base, 11, is a shaft alignment device, 12. The shaft alignment device, 12, is preferably a V-trough within which the shaft rest and the shaft is restricted from moving from side to side. Attached to the side of the base is a ruler, 13, which is preferably attached to insure that it does not move during use. At least one indexing guide, 14, slidably mounted to the base, is used to determine the distances of each club relative to the ruler. Multiple indexing guides may be attached to the base. The indexing guide, 14, comprises an attachment device, 15, which can be used to reversibly secure the indexing guide in a specific position along the base. An alignment plate, 16, contacts the sole of the golf head, 17. Attached to the alignment plate, 16, is a slide, 18. The slide is slidably attached to the alignment plate and aligns with the grooves, 19, of the club head, 17. The golf head is rotated such that the slide is in contact with the face of the golf club for the entire length. It would be apparent to a skilled artisan that the combination of the slide being aligned with the grooves and in contact with the face and the sole of the golf head being in contact with the alignment plate insures that the position of the club head is fixed relative to the whole of the golf shaft measuring apparatus. The shaft, 20, rest in the shaft alignment device, 12, thereby accurately placing the shaft in the correct position for measuring relative to the ruler. The indexing guide, 14, is set such that each peak, 21, indicates the proper length for a specific club in the matched set. For example, if a standard set is being prepared each peak would be separated from the next peak by ½ inch.

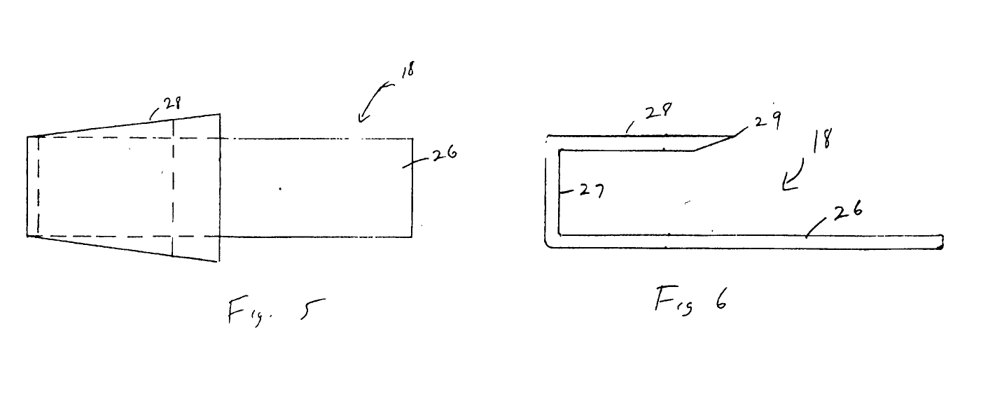

FIG. 4 is a detailed view of the alignment plate and associated assembly. The alignment plate, 16, is rotatably attached to the base, 11, by an axle, 22. A slide mount, 23, forms a groove, 24, which slidably receives the slide (not shown). It would be apparent that the slide can be received on either side of the alignment plate and is therefore usable for right handed or left handed golf club manufacture. An indexing groove, 25, receives the locking mechanism for the indexing guide which will be illustrated below.

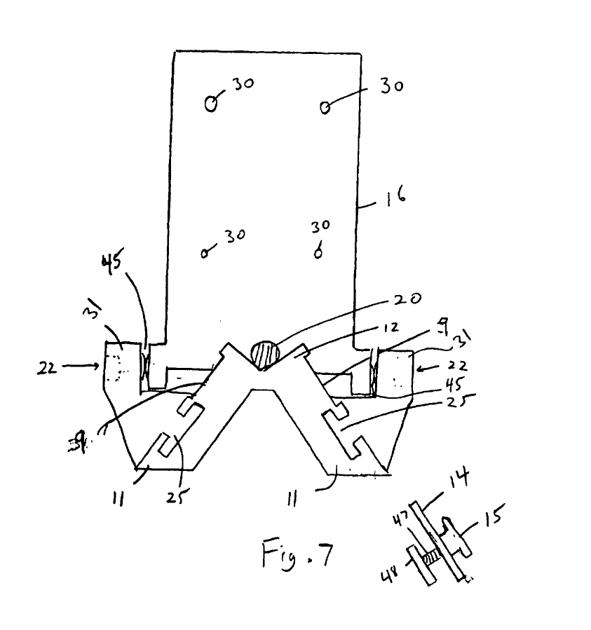

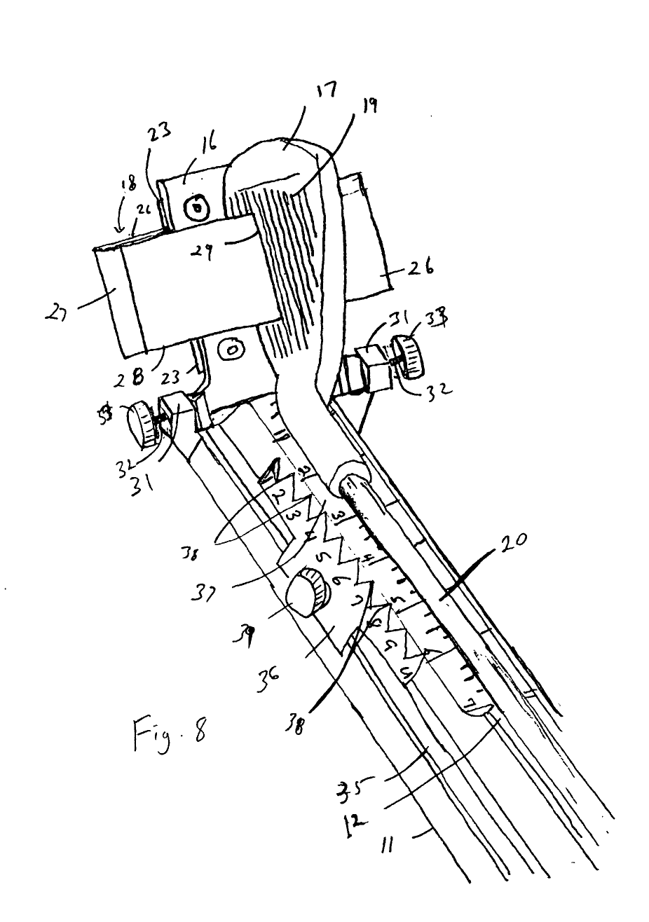

FIG. 5 is a top view of a preferred slide and FIG. 6 is a side view of the same slide. The slide, generally represented at 18, comprises a slide base, 26, which is received by the groove, 24, illustrated in FIG. 4. A riser, 27, connects the groove aligner, 28, and slide base, 26 and provides an offset which insures that the grooves can be aligned even with large soled clubs as common with a sand wedge, for example. The groove aligner preferably terminates at a knife edge, 29, to increase the accuracy. It is most preferable that the knife edge has an angle of at least 40° with at least 60° being more preferable. A knife edge of 70° has been demonstrated to be exemplary. While shown as a single bevel the knife edge could comprise a double bevel without departing from the scope of the present invention. It is the purpose of the knife edge to accurately and clearly align with the grooves of the golf club. Therefore, the dimensions are preferably such that the knife edge can be at least slightly inserted into the grooves to improve accuracy.

FIG. 7 is an end view of a preferred embodiment golf shaft measuring apparatus. The base, 11, is preferably generally symmetrical to allow the device to be used on either side for assembly of right handed and left handed golf clubs. A generally “V-shaped” base is preferable since this requires less material and the weight is lower without sacrificing strength. On either side of the base is an indexing groove, 25, within which the locking mechanism of the index guide (not shown) transits. The indexing guide typically comprises an attachment device which includes a threaded male member with a mating threaded female member located within the indexing groove, 25. As the male member is rotated the female member is drawn closer which creates friction between the female member and the indexing groove thereby securing the indexing guide in position. An optional, but preferred ruler slot, 9, provides a location for securing the ruler without the ruler protruding beyond the surface of the apparatus. In a particularly preferred embodiment concave washers, 45, are inserted between the alignment plate, 16, and the alignment plate base, 31, attached to the base, 11, such that the axle will be received there through. Multiple concave washers, 45, can be used in alternating opposition to act as a spring mechanism. This allows the force required to rotate the alignment plate to be adjusted by the tension of the axle. A spring could also be used instead of the concave washers. The indexing guide, 14, is slidably received by the indexing groove, 25, of the base, 11. The attachment device, 15, preferably comprises a threaded member, 47, which is rotationally received by a tension nut, 48. The tension nut is preferably a shape which will not rotate in the indexing groove, 25, such as rectangular. The threaded member can therefore slide in the throat of the indexing groove and the position can be fixed by rotating the attachment device, 15, to draw the tension nut and indexing guide into a frictional gripping relationship with the indexing groove. The tip indexing groove could work in an analogous manner. The tension nut and attachment device may be manufactured from any material known in the art for such devices but particularly preferred are metal and polymeric materials such as teflon®, nylon or lexsand.

The shaft, 20, rest in the shaft alignment device, 12, which preferably has the shape of a “V” as illustrated in the drawings. Other shapes such as rounded, or portions of pentagons, hexagons, etc. could be used without departing from the scope of the invention. The alignment plate, 16, is shown in the vertical position and includes mounting holes, 30, through which threaded members may be inserted to attach the slide mount (not shown) to the back side of the slide alignment plate.

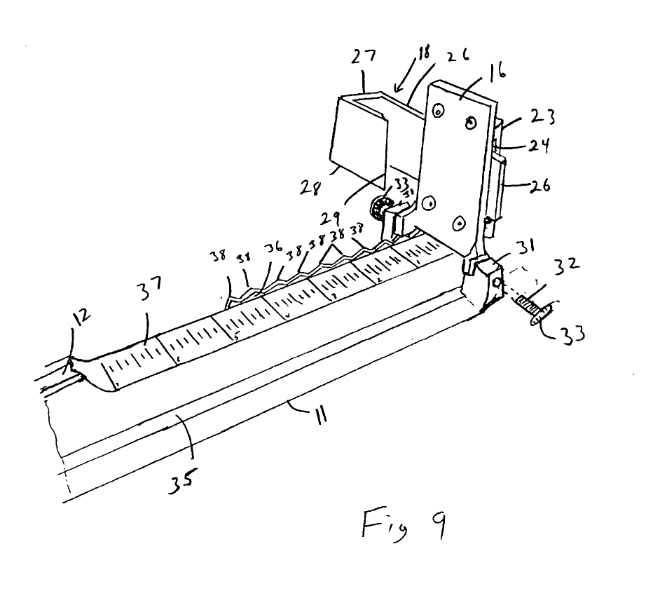

FIG. 8 is a perspective view of the apparatus with a golf club inserted as it would be viewed in use with a right-handed golf club. The golf head, 17, has attached thereto a shaft, 20. The shaft, 20 rest in the shaft alignment device, 12. To insure that the golf head and shaft are in the proper rotational position the knife edge, 29, contacts the face of the golf head and is parallel to the grooves, 19. It is preferable that the knife edge is in contact with golf head for the entire length of the knife edge when a single knife edge is utilized as illustrated in FIG. 8. For partially concave or convex golf heads an alternate embodiment is preferable as described in reference to FIG. 13.

Referring again to FIG. 8, the alignment plate, 16, with attached slide mount, 23, is pivotally attached the alignment plate base, 31, which is preferably integral to the base, 11. A pair of axles, 32, allow the alignment plate to pivot relative to the axis of the axles. The axles, 32, may further comprise handles, 33, which allow the tension to be increased such that the ease with which the alignment plate, 16, rotates can be adjusted. Washers, or springs, as described relative to FIG. 7 could be utilized with the axle if so desired. Slidably attached to a tip groove, 35, is a shaft indexing guide, 36. The tip groove, 35, may be a continuation of the indexing groove (25 of FIG. 7) or it may be a separate and distinct groove in the base. It is preferable that the indexing groove and tip groove be the same since this allows the base to be extruded, or cast as a continuous piece which is most desirable. If the device is intended to be folded or taken apart the single extruded piece can be cut and a hinge added or alignment bores and pins as would be apparent to one of ordinary skill in the art. The tip indexing guide is used to measure the tip of a shaft or cutting prior to attaching the golf head. In using the tip indexing guide, 36, the alignment plate, 16, is rotated to a position which is perpendicular to the shaft alignment device, 12, or to a representative structure indicating that the alignment plate is perpendicular to the axis of the shaft. The shaft is then placed in the shaft alignment device and abutted to the alignment plate. The tip indexing guide, 36, is then adjusted relative to a shaft ruler, 37, such that each peak, 38, of the tip indexing guide corresponds to the length from the alignment plate that the tip of a shaft should be cut. The indexing guide is adjusted laterally by a knob, 39, which can be loosened to move the tip indexing guide and tightened to reversibly fix the tip indexing guide in position.

FIG. 9 is a side view of the apparatus of FIG. 8 from the back side without a golf club, or shaft, present so that the elements can be visualized without obstruction. This is the view that would be seen if assembling a left handed club except that the slide would be withdrawn and reinserted in the opposite side of the slide mount, 23. It would be apparent that the tip indexing guide is ambidextrous and could be used on either side. Two tip indexing guides could be used but this is not normally necessary since the handedness of the golf club is not established until the golf club head is attached to the shaft.

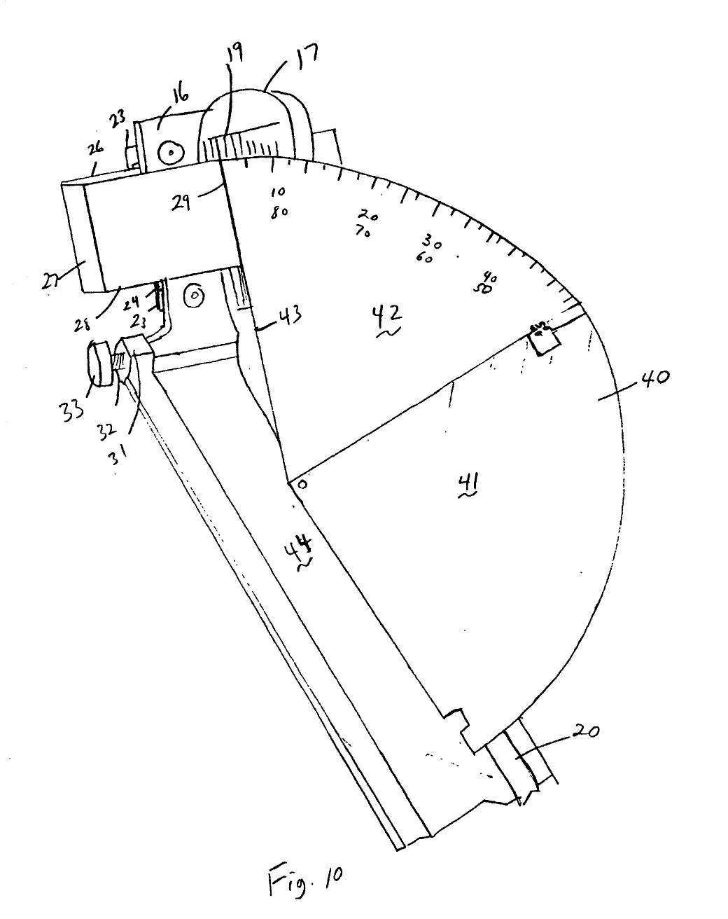

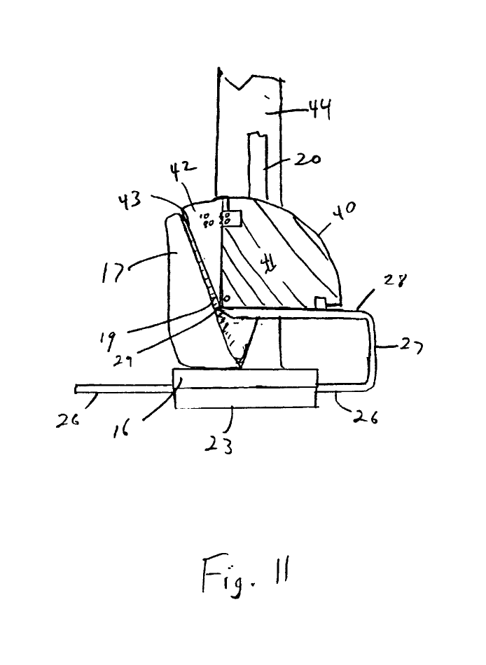

FIG. 10 is a perspective view of the apparatus as used for determining the lie of a golf club. The golf club is inserted into the device as described relative to FIG. 8. A protractor, 40, comprising an indexing section, 41, and angle section, 42, is laid on the base at a surface, 44, which is parallel to the shaft axis. The surface may be the shaft ruler, the upper surface of the shaft alignment device or a separate structural element may be added for use with a lie meter without departing from the scope of the invention. The angle section, 42, of the protractor, 40, is rotated such that the protractor edge, 43, is parallel to the groove aligner, 28. The lie angle is the angle between the axis of the shaft and the groove aligner which corresponds to the grooves. This represents a substantial improvement over the prior art. Since the position of the shaft is fixed and secure and the position of the golf head is precisely maintained, there is no need for the operator to project an imaginary line of the shaft axis as typically required in lie determination. The method of the present invention is accurate and repeatable and does not require the cost associated with separate pieces of equipment wherein one measures lie and loft and one measures shaft length.

FIG. 11 is a top side view illustrating the method utilized for determining the loft of a golf club. The loft is the angle between the plane of the face of the clubhead and a vertical plane which extends through the centerline of the shaft. By securing the golf club in the inventive device, as described relative to FIG. 8, the alignment plate, 16, is perpendicular to a plane which includes the centerline of the shaft. Therefore, the groove aligner, 28, can be used as a point of reference for determining the loft of the club face. The indexing section, 41, of the protractor, 40, is placed in a position which is parallel to the groove aligner, or alignment plate. The protractor edge, 43, is then brought into contact with the club face and the loft is determined by the angle reported on the angle section, 42. This insures that the loft is accurate, repeatable and rapidly determined which is a combination not currently available in the art.

While the indexing guides are illustrated and described as slidably mounted to the base it is contemplated that the indexing guide could comprise a gear or belt mechanism such that rotation of the knob or handle would move the indexing guide along the base. The indexing guide could also be indexed such that the indexing guide could be moved to various discreet levels along the indexing guide.

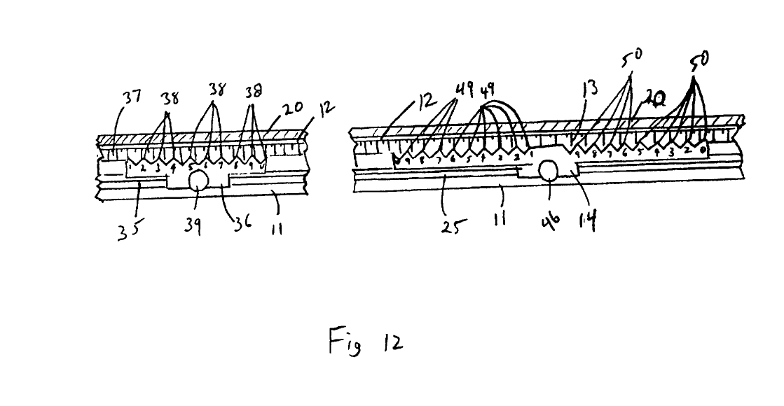

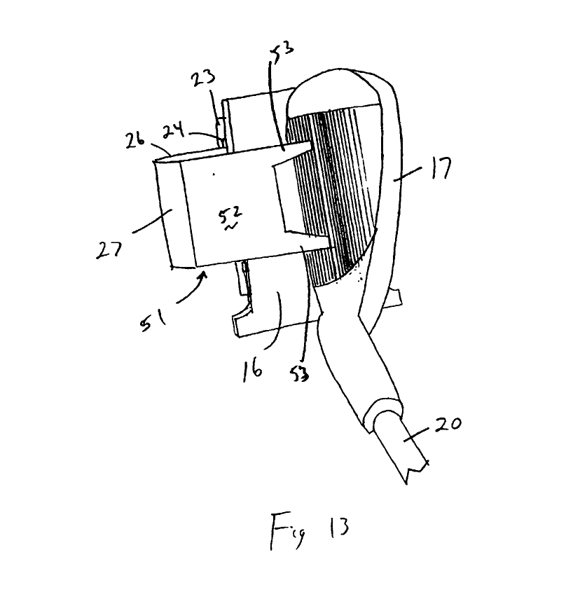

FIG. 12 is a side partial view illustrating preferred indexing guides. The tip indexing guide, 36, is slidably received within the tip groove, 35. The tip groove may be continuous with the indexing groove, 25, or may be a separate and distinct groove. The tip indexing guide comprises a plurality of peaks, 38, each of which corresponds to a desired length of the tip which will be cut off during the initial stages of club manufacture. As known in the art, the tip of each shaft of a matched set is preferably cut with the largest portion cut for the highest loft club. For example, in a standard set the six iron will have more tip removed than the five iron and less than the seven iron. The difference between each shaft length is determined by standards set by the industry and may change without departing from the scope of the present invention. Currently, a separation of 0.5″ is a preferred separation between peaks, 38. It is also contemplated that custom designs could utilize different separation. A knob, 39, allows movement of the shaft tip guide along the groove as described previously herein.

A preferred indexing guide, 14, allows for indexing clubs from a utility wedge to a driver. As illustrated in FIG. 12, the iron indexing peaks, 49, are separated by the same difference as the difference in shaft length. For example, an eight iron has a longer shaft than a nine iron but shorter than a seven iron. It is optional for the same indexing guide, 14, to have both iron indexing peaks, 49, and wood indexing peaks, 50, on the same indexing guide. In another embodiment, two separate indexing guides can be used wherein one is specific for irons and one for woods. It would also be apparent that a mirror image of the indexing guide, 14, would be used for left-handed clubs since turning the indexing guide around would reverse the indexing. The indexing guide, 14, traverses in an indexing groove, 25. A handle, 46, allows the indexing guide to be fixed in place or moved along the groove as described previously herein.

FIG. 13 is a perspective partial view of another embodiment of the slide, 51. The groove aligner, 52, comprises a multiplicity of spaced apart club face contact points, 53, which align the club face as previously described. The spaced club face contact points allow accurate alignment of clubs which are concave, convex or any surface which is not flat.

The term “iron” and “wood” when referring to golf clubs is used as the standard usage in the art. Irons typically refer to a bladed club with a loft which decreases as the number of the iron decreases. A wood is typically a mallet in design, made from wood, metal or composites, and the loft decreases as the number decreases. It would be apparent from the description herein that the terms iron and wood do not limit the invention but merely reference the standard vernacular as used in the art for the manner in which the invention would be used.

The material of construction is not limited in the present invention. The attributes which are preferable include strength, and weight with an exemplary embodiment available from Accumade Inc. of Huntsville, Ala. Most preferably, the base and shaft alignment device are a single extruded construction, however, they may be separate elements which are attached by any of the methods known in the art.

Claimed is:

1. A golf shaft measuring device comprising:
a base;
a shaft alignment device capable of aligning said golf shaft in a position relative to said base;
an alignment plate pivotally attached to said base and capable of abutting said golf shaft; and
an indexing guide slidably attached to said base.

2. The golf shaft measuring device of claim 1 wherein said shaft alignment device is v-shaped.

3. The golf shaft measuring device of claim 1 wherein said base and said shaft alignment device are a single element.

4. The golf shaft measuring device of claim 1 wherein said indexing guide comprises peaks.

5. The golf shaft measuring device of claim 1 further comprising a slide slidably attached to said alignment plate.

6. The golf shaft measuring device of claim 5 wherein said alignment plate is parallel to said slide.

7. The golf shaft measuring device of claim 5 wherein said golf shaft comprises a golf head with a groove and said slide aligns parallel to said groove when said golf head contacts said alignment plate.

8. The golf shaft measuring device of claim 7 wherein said slide comprises a at least two contact points for contacting said golf head.

9. The golf shaft measuring device of claim 5 wherein said slide comprises a groove aligner.

10. A device for measuring a golf shaft comprising a golf head wherein said device comprising:
a base;
a shaft alignment device attached to said base;
an alignment plate pivotally attached to said base and capable of contacting golf head;
a slide wherein said slide comprises a groove aligner parallel to said alignment plate and wherein said alignment plate can be rotated such that said groove aligner is parallel to a groove on said golf head when said golf head is in contact with said alignment plate;
and
an indexing guide slidably attached to said base.

11. The device for measuring a golf shaft of claim 10 further comprising a ruler attached to said base.

12. The device for measuring a golf shaft of claim 10 comprising two indexing guides.

13. The device for measuring a golf shaft of claim 12 wherein one of said two indexing guides is a tip indexing guide.

14. A method for determining a golf club lie angle comprising the steps of:
a) placing said golf club in a golf club alignment device comprising a shaft alignment device;
an alignment plate attached perpendicular to said shaft alignment device and in contact with a golf head of said golf club; and
a slide attached to said alignment plate wherein said slide is parallel to a groove of said golf head;
b) placing a protractor on said golf club alignment device wherein said protractor comprises an indexing section and an angle section and said protractor is oriented such that said alignment section is parallel to said shaft and said angle section is parallel to said slide;
and
c) reading an angle on said protractor corresponding to said lie angle.

15. A method for determining a loft angle of a golf club wherein said golf club comprises a shaft and a golf head and said golf head comprises a sole, a face and a groove, said method comprising the steps of:
a) placing said golf club in a golf club alignment device comprising a shaft alignment device for orienting said shaft;
an alignment plate in contact with said sole; and
a slide parallel to said alignment plate and parallel to said groove;
b) placing a protractor on said golf club alignment device wherein said protractor comprises an indexing section and an angle section and said protractor is oriented such that said alignment section is parallel to said alignment plate and said angle section is parallel to said face; and
c) reading an angle on said protractor corresponding to said loft angle.

16. A method for forming a golf club from a golf shaft and a golf head comprising the steps of:
a) placing said golf shaft in a shaft alignment device wherein said shaft alignment device comprises a alignment plate rotatable to a position perpendicular to said golf shaft;
b) measuring said golf shaft with an tip indexing guide wherein said tip indexing guide comprises a peak indicating the length of said golf shaft to remove;
c) removing a portion of said golf shaft corresponding to said peak;
d) attaching said golf head to said shaft;
e) placing said shaft in said shaft alignment device and contacting said golf head with said alignment plate wherein said alignment plate comprises a slide parallel to said alignment plate and said alignment plate is rotated such that said slide is parallel to a groove of said golf head;
f) measuring said golf shaft with an indexing guide wherein said indexing guide comprises a length peak indicating the length of said club: and
g) removing a portion of said shaft corresponding to said length peak.

17. The method of claim 16 further comprising the step of:
h) attaching a handle to said golf shaft opposite to said golf head.
